(19) United States
(12) Patent Application Publication
(10) Pub. No.: US 2003/0018949 A1
(43) Pub. Date: Jan. 23, 2003

(54) Method and apparatus for laying out wires on a semiconductor integrated circuit

(76) Inventor: Manabu Yoshida, Kasugai (JP)

Correspondence Address: STAAS & HALSEY LLP, 700 11TH STREET, NW, SUITE 500, WASHINGTON, DC, 20001, US

(21) Appl. No.: 10/087,803

(22) Filed: Mar. 5, 2002

(30) Foreign Application Priority Data
Jul. 19, 2001 (JP) 2001-219815

(51) Int. Cl. G06F 17/50

(52) U.S. Cl. 716/14; 716/12; 716/2; 716/5

(57) ABSTRACT

A method for laying out wires in a semiconductor integrated circuit at intervals corresponding to potential differences between nets. A CPU uses a netlist stored in a first file, names and voltages of power supply nets that are stored in a second file, and names and power supply voltages of external input nets stored in a third file to search for nets of equal potentials. The CPU forms groups from nets of equal potentials and obtains the potential at each net. The CPU calculates the potential difference between the nets and sets wire intervals in accordance with the calculated potential differences. The CPU generates wire layout data so that the set intervals are provided.

### BACKGROUND OF THE INVENTION

The present invention relates to a method and apparatus for laying out wires in a semiconductor integrated circuit at intervals corresponding to potential differences.

Copper (Cu) wires are used in semiconductor integrated circuits. The application of a voltage to the wires may cause copper to spread out of the copper wires. This may short-circuit adjacent wires. Thus, adjacent wires must be spaced from one another by a proper distance in accordance with the level of the voltage applied to each wire.

In the prior art, a netlist to which the attribute of wire intervals is added, or connection information of the circuit wiring, is used to optimize the interval between the wires.

However, in a semiconductor integrated circuit having many nets, much time is required to add the attribute of wire intervals for every net. Thus, it is virtually impossible to add the attribute to every net in recent large-scale semiconductor integrated circuits.

### SUMMARY OF THE INVENTION

It is an object of the present invention to provide a method and apparatus for laying out wires in a semiconductor integrated device at optimal intervals corresponding to potential differences between nets.

To achieve the above object, the present invention provides a method for laying out wires in a semiconductor integrated circuit. The method includes recognizing potentials at nets, each net including at least one of the wires, calculating potential differences between the nets using the recognized potentials at the nets, determining wire intervals in correspondence with the calculated potential differences, and generating wire layout data in accordance with the determined wire intervals.

A further perspective of the present invention is a method for examining wire layout data of a semiconductor integrated circuit having a plurality of wires. The method includes recognizing potentials at nets, each net including at least one of the wires, calculating potential differences between the nets using the recognized potentials at the nets, setting reference wire intervals in correspondence with the calculated potential differences, and examining whether the reference wire intervals are provided by comparing the reference wire intervals and wire intervals in the wire layout data.

A further perspective of the present invention is an apparatus for laying out wires in a semiconductor integrated circuit having nets, each net including at least one of the wires. The apparatus includes a memory for storing a netlist recognizing potentials at the nets, and a processing unit for calculating potential differences between the nets based on information stored in the memory, determining wire intervals in correspondence with the calculated potential differences, and generating wire layout data in accordance with the determined wire intervals.

A further perspective of the present invention is a program for laying out wires in a semiconductor integrated circuit. The program causes a computer to execute the steps of recognizing potentials at nets, each net including at least one of the wires, calculating potential differences between the nets using the recognized potentials at the nets, determining wire intervals in correspondence with the calculated potential differences, and generating wire layout data in accordance with the determined wire intervals.

A further perspective of the present invention is a computer readable recording medium storing a program for laying out wires in a semiconductor integrated circuit. The recording medium causes a computer to execute the steps of recognizing potentials at nets, each net including at least one of the wires, calculating potential differences between the nets using the recognized potentials at the nets, determining wire intervals in correspondence with the calculated potential differences, and generating wire layout data in accordance with the determined wire intervals.

A further perspective of the present invention is a method for designing the layout of a semiconductor integrated circuit that includes a plurality of wires. The method includes recognizing potentials at nets, each net including at least one of the wires, generating an informational netlist of those potentials that are recognized (a “potential-recognized netlist”), calculating potential differences between the nets using the potential-recognized netlist, classifying the calculated potential differences, setting reference wire intervals in correspondence with the calculated potential differences, and generating layout data of the wires in accordance with the reference wire intervals.

A further perspective of the present invention is a method for examining wire layout data of a semiconductor integrated circuit having a plurality of wires. The method includes recognizing potentials at nets, each net including at least one of the wires, generating a potential-recognized netlist including information of the recognized potentials, calculating potential differences between the nets using the potential-recognized netlist, classifying the calculated potential differences, setting reference wire intervals in correspondence with the calculated potential differences, and examining whether wire intervals in the wire layout data satisfy the reference wire intervals by comparing the reference wire intervals with the wire intervals in the wire layout data.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a schematic block diagram of an apparatus for laying out wires in a semiconductor integrated circuit according to a first embodiment of the present invention;

FIG. 2 is a flowchart illustrating a wiring design process performed by the apparatus of FIG. 1;

FIG. 3 is a circuit diagram of a semiconductor integrated circuit;

FIG. 4 is a table illustrating an original netlist; FIGS. 5A to 5E are tables used during an equal potential searching process;

FIG. 6 is a circuit diagram illustrating recognized potentials at nets;

FIG. 7 is a table illustrating a potential-recognized netlist;

FIGS. 8A and 8B are tables used to determining potential difference type;

FIG. 9 is a table for determining wire intervals; and

FIG. 10 is a layout diagram of a semiconductor integrated circuit.

### DETAILED DESCRIPTION OF THE PREFERRED EMBODIMENTS

An apparatus for laying out wires of a semiconductor integrated circuit according to a preferred embodiment of the present invention will now be discussed.

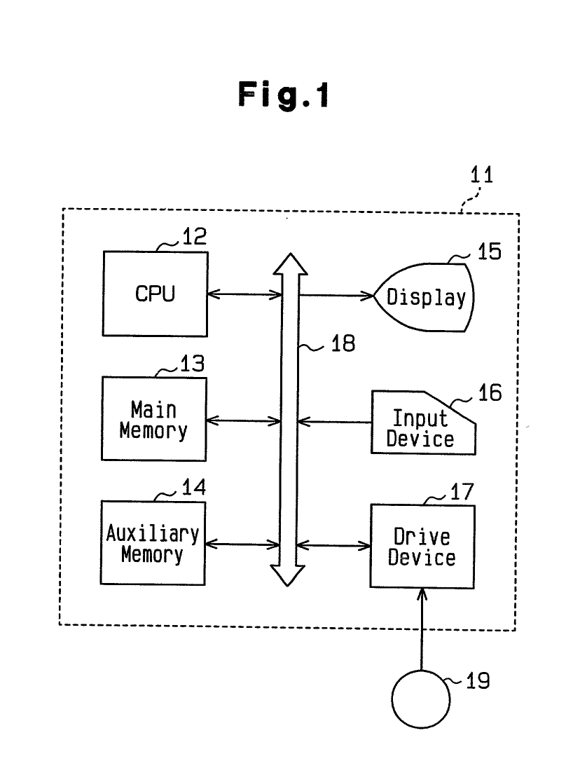

With reference to FIG. 1, a layout apparatus 11, which is a computer aided design (CAD) apparatus, includes a central processing unit (CPU) 12, a main memory 13, an auxiliary memory 14, a display 15, an input device 16, and a drive device 17, which are connected to one another by a bus 18.

The CPU 12 executes programs stored in the main memory 13 to design the wiring of a semiconductor integrated circuit. The main memory 13 includes a cache memory, a system memory, and a display memory.

The display 15, which may be a cathode ray tube (CRT), a liquid crystal display (LCD), or a plasma display panel (PDP), displays laid out wires and a parameter input screen. The input device 16, which is used to input user requests and commands, such as parameters, includes a keyboard and a mouse (neither shown).

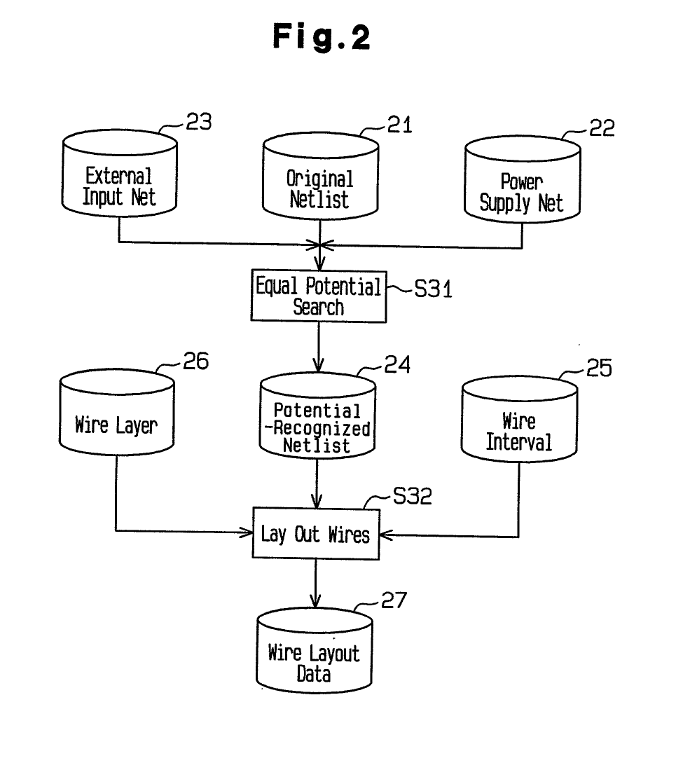

The auxiliary memory 14 may be a magnetic disk, an optical disc, or a magneto-optic disc. Referring to FIG. 2, the auxiliary memory 14 stores program data and first through seventh files 21-27, which are used in the wiring design process. In response to commands input by the input device 16, the CPU 12 transfers programs and data from the first through seventh files 21-27 to the main memory 13 to execute the programs. The auxiliary memory 14 may be used as a database.

The drive device 17 reads data from and/or records data to a recording medium 19. The recording medium 19 is a computer readable medium, such as a magnetic tape (MT), a memory card, a floppy disc, an optical disc (CD-ROM, DVD-ROM), or an optical magnetic disc (MO, MD). Program data and the first to seventh files 21-27 may be stored in the recording medium 19. In such case, the CPU 12 loads programs and data from the recording medium 19 to the main memory 13 when necessary to execute the programs.

The recording medium 19 may be a medium or disc device that records program data provided via a communication medium. Further, the recording medium 19 does not have to be a recording medium that records programs directly executed by a computer and may be a recording medium that records programs executed when installed in another recording medium (e.g., hard disk) or may be a recording medium that records coded or compressed programs.

A process for laying out wiring will now be discussed with reference to FIGS. 2 to 10.

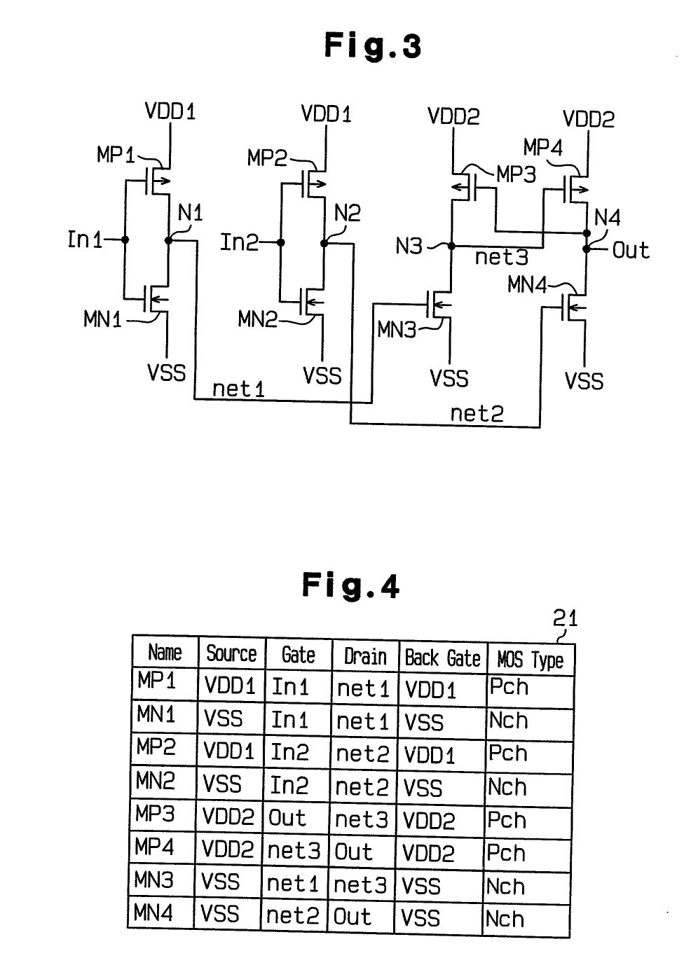

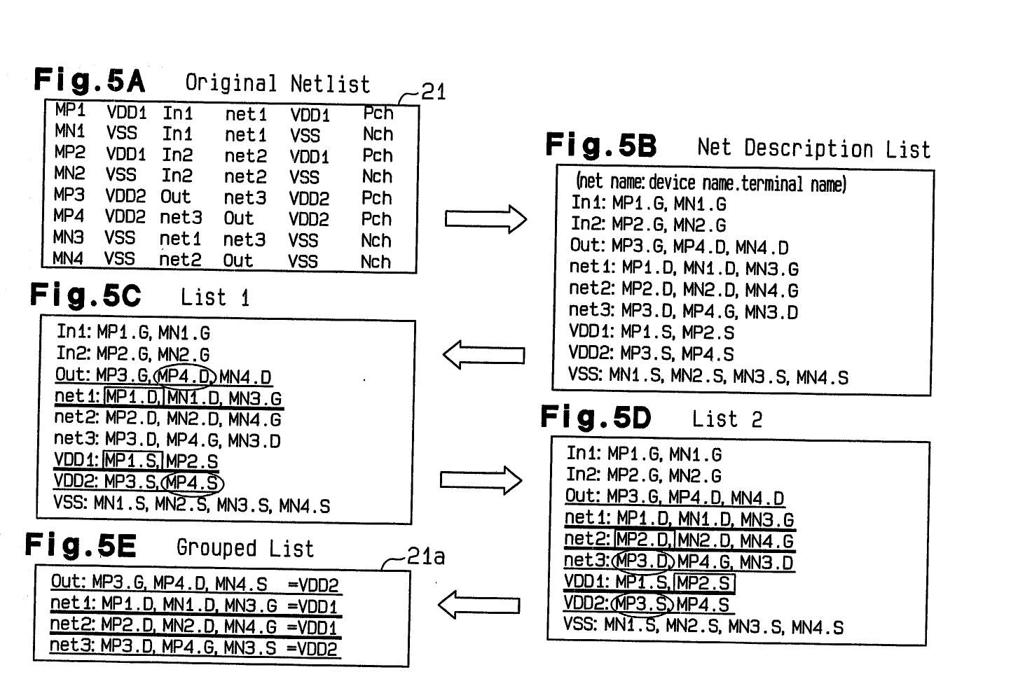

Referring to FIG. 2, the first file 21 stores design data (netlist) of a semiconductor integrated circuit designed by, for example, a CAD apparatus (not shown). The first file 21, for example, stores an original netlist (FIG. 4) of a semiconductor integrated circuit shown in FIG. 3.

The semiconductor integrated circuit of FIG. 3 will now be discussed. The semiconductor integrated circuit, which is a multiple power supply circuit provided with two or more power supplies VDD1, VDD2, includes first to fourth p-channel MOS transistors MP1-MP4 and first to fourth n-channel MOS transistors MN1-MN4. The first to fourth PMOS transistors MP1-MP4 are respectively connected in series with the first to fourth NMOS transistors MN1-MN4.

The gate of the first PMOS transistor MP1 and the gate of the first NMOS transistor MN1 receive an input signal In1. The source of the first PMOS transistor MP1 is connected to a first high potential power supply VDD1, and the source of the first NMOS transistor MN1 is connected to a low potential power supply VSS (0V).

A node N1 between the drain of the first PMOS transistor MP1 and the drain of the first NMOS transistor MN1 is connected to the gate of the third NMOS transistor MN3. The gate of the second PMOS transistor MP2 and the gate of the second NMOS transistor MN2 receive an input signal In2. The source of the second PMOS transistor MP2 is connected to the first high potential power supply VDD1, and the source of the second NMOS transistor MN2 is connected to the low potential power supply VSS. A node N2 between the drain of the second PMOS transistor MP2 and the drain of the second NMOS transistor MN2 is connected to the gate of the fourth NMOS transistor MN4.

The source of the third PMOS transistor MP3 is connected to a second high potential power supply VDD2, and the source of the third NMOS transistor MN3 is connected to the low potential power supply VSS. A node N3 between the drain of the third PMOS transistor MP3 and the drain of the third NMOS transistor MN3 is connected to the gate of the fourth PMOS transistor MP4. The source of the fourth PMOS transistor MP4 is connected to the second high potential power supply VDD2, and the source of the fourth NMOS transistor MN4 is connected to the low potential power supply VSS. A node N4 between the drain of the fourth PMOS transistor MP4 and the drain of the fourth NMOS transistor MN4 is connected to the gate of the third NMOS transistor MP3. An output signal Out is output from node N4.

Referring to FIG. 4, the original netlist of the semiconductor integrated circuit defines the MOS type and connection information, which includes source, gate, drain, and back gate, of each of the transistors MP1-MP4, MN1-MN4. For example, the first PMOS transistor MP1 is defined by VDD1 (source), In1 (gate), net1 (drain), VDD1 (back gate), and p-channel (MOS type). In the netlist, net1-net3 each represents an intermediate net that connects transistors.

The second file 22 stores the name (e.g., VDD1, VDD2) of each power supply net and the voltage data of each power supply net. The third file 23 stores the name (e.g., In1, In2) of each external power supply net, or external input net, and the voltage data of each external power supply net. A user inputs data using keys to store data in the second and third files 22, 23.

In a first step, S31 of FIG. 2, the CPU 12 reads the original netlist and power supply names from the first to third files 21-23 and searches for equal potentials in the read data.

The equal potential searching, or the search for wires of equal potentials will now be discussed with reference to FIGS. 5A to 5E.

The CPU 12 first converts the original netlist, which is shown in 5A to a net description list, which is shown in FIG. 5B. In the net description list, each net unit is indicated in the format of “net name: device name (instance name). terminal name”. For example, “In1: MP1.G, MN1.G” indicates that input net In1 is connected to the gate (G) of the transistor MP1 and the gate of the transistor MN1. The other nets In2, Out, net1-net3, VDD1, VDD2, and VSS are described using the same format.

When a transistor is activated, the potential at the source (S) of the transistor is equal to the potential at the drain (D) of the transistor. Accordingly, the CPU 12 searches for nets having potentials equal to the power supply nets VDD1, VDD2 and forms groups based on equal potentials. More specifically, when the transistors MP1, MN1 are activated, the potential at the source of the transistor MP1 (MP1.S), which is connected to the first power supply net VDD1, is equal to the potential at the drain of the transistor MP1 (MP1.D), which is connected to the first intermediate net net1. When the transistors MP4, MN4 are activated, the potential at the source of the transistor MP4 (MP4.S), which is connected to the second power supply net VDD2, is equal to the potential at the drain of the transistor MP4 (MP4.D), which is connected to the output net Out. Accordingly, the CPU 12 defines the first intermediate net net1 and the first power supply net VDD1 as a first group and defines the output net Out and the second power supply net VDD2 as a second group, as shown in list 1 of FIG. 5C.

In the same manner, when the transistors MP2, MN2 are activated, the potential at the source of the transistor MP2 (MP2.S), which is connected to the first power supply net VDD1, is equal to the potential at the drain of the transistor MP2 (MP2.D), which is connected to the second intermediate net net2. When the transistors MP3, MN3 are activated, the potential at the source of the transistor MP3 (MP3.S), which is connected to the second power supply net VDD2, is equal to the potential at the drain of the transistor MP3 (MP3.D), which is connected to the third intermediate net 3. Accordingly, the CPU 12 includes the second intermediate net net2 in the first group, which also includes the first power supply net VDD1, and includes the third intermediate net net3 in the second group, which also includes the second power supply net VDD2, as shown in list 2 of FIG. 5D.

By repeating the equal potential searching, the first and second intermediate nets net1, net2 are included in the first group, the power supply of which is the first power supply net, and the third intermediate net net3 and the output net Out are included in the second group, the power supply of which is the power supply net VDD2. In this manner, the CPU 12 generates a grouped list 21a, as shown in FIG. 5E.

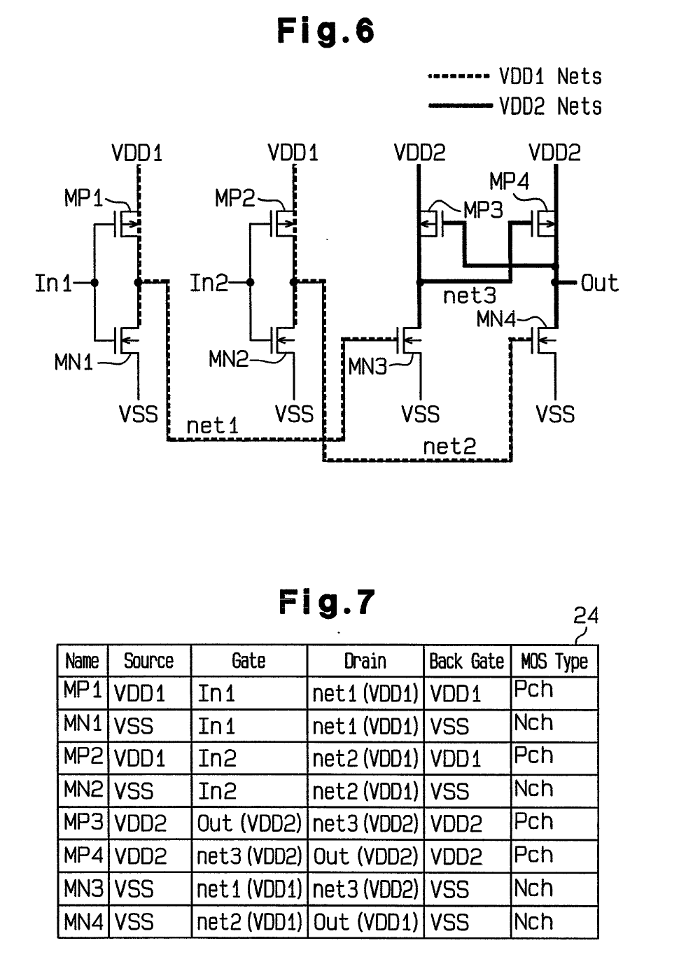

Referring to FIG. 6, from the results of the equal potential searching, the power supply potentials at each of the nets net1-net3, or the maximum potential provided to each net, is recognized. More specifically, the maximum potential at the first and second intermediate nets net1, net2 is equal to the potential at the first power supply VDD1, and the maximum potential at the third intermediate net net3 and the output net Out is equal to the potential at the second power supply net VDD2.

Based on the result of step S31 in FIG. 2, the CPU 12 generates a netlist to which the potential attribute is added (FIG. 7). A predetermined potential (initial value) defined in the third file 23 is added to the potential attributes of the input nets In1, In2. The CPU 12 temporarily stores the netlist to which the potential attributes are added in the fourth file 24.

The fifth file 25 stores information of wire intervals, which are set in correspondence with the combination of two potentials. The sixth file 26 stores information of wire layers. In step S32, the CPU 12 reads data from the fourth to sixth files 24-26 and generates layout data based on the read data. The CPU 12 stores circuit data, which includes layout data, in the seventh file 27.

Step S32 will now be discussed.

The semiconductor integrated circuit of FIG. 3 may take the potentials of 0(V), VDD1(V), VDD2(V), 0-VDD1(V), and 0-VDD2 (V). More specifically, the potential at the low potential power supply VSS is 0V. When the transistors MP1, MP2 are activated and the transistors MN1, MN2 are deactivated, the potential at the first and second intermediate nets net1, net2 is VDD1. On the other hand, when the transistors MP1, MP2 are deactivated and the transistors MN1, MN2 are activated, the potential at the first and second intermediate nets net1, net2 is VSS. That is, the potential at the first and second intermediate nets net1, net2 varies between 0-VDD1. In the same manner, the potential at the third intermediate net net3 and the output net Out varies between 0-VDD2. Accordingly, the potential at the nets net1, net2 is set to 0-VDD1, and the potential at the nets net3, Out is set to 0-VDD2.

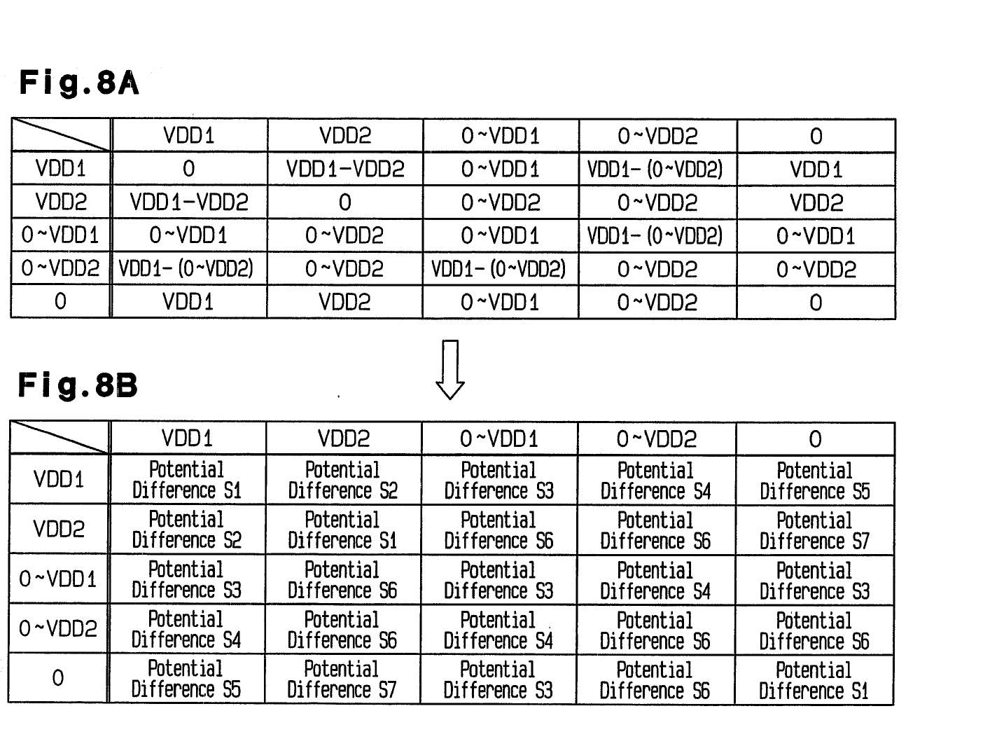

FIG. 8A is a matrix table illustrating potential differences between nets. The CPU 12 classifies the potential differences of the matrix table in FIG. 8A to generate the matrix table of FIG. 8B. As shown in the matrix table of FIG. 8B, the semiconductor integrated circuit has seven types of potential differences S1-S7. More specifically, in the matrix table of FIG. 8B, potential difference S1 corresponds to 0(V), potential difference S2 corresponds to VDD1-VDD2, potential difference S3 corresponds to 0-VDD1, potential difference S4 corresponds to VDD-(0-VDD2), potential difference S5 corresponds to VDD1, potential difference S6 corresponds to 0-VDD2, and potential difference S7 corresponds to VDD2. In this manner, the CPU 12 uses the matrix table to determine the potential difference between related nets. Instead of the CPU 12, a user may determine the potential difference.

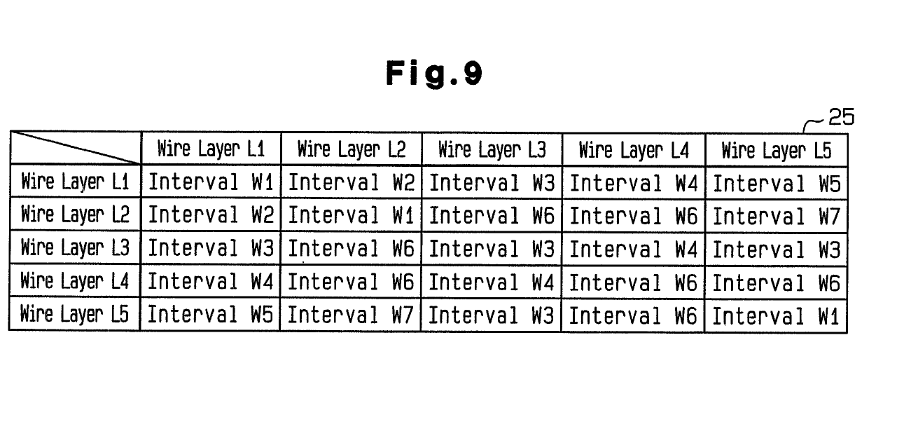

The CPU 12 replaces the potentials of the matrix table of FIG. 8B (VDD1, VDD2, 0-VDD1, 0-VDD2, 0) respectively with wire layers L1-L5, replaces potential differences S1-S7 respectively with wire intervals W1-W7, and generates interval definition information, or a matrix table (FIG. 9). The wire intervals W1-W7 are minimum intervals (reference values) set in accordance with the level of the potential differences S1-S7, respectively. The interval definition information is stored in the fifth file 25. The relationship between the combination of the wire layers L1-L5 and the wire intervals W1-W7 is as shown in table 1.

TABLE 1

| Number | Wiring Layer | Wiring Layer | Wiring Interval |
|---|---|---|---|
| 1 | L1 | L1 | W1 |
| 2 | L1 | L2 | W2 |
| 3 | L1 | L3 | W3 |
| 4 | L1 | L4 | W4 |
| 5 | L1 | L5 | W5 |
| 6 | L2 | L2 | W1 |
| 7 | L2 | L3 | W6 |
| 8 | L2 | L4 | W6 |
| 9 | L2 | L5 | W7 |
| 10 | L3 | L3 | W3 |
| 11 | L3 | L4 | W4 |
| 12 | L3 | L5 | W3 |
| 13 | L4 | L4 | W6 |
| 14 | L4 | L5 | W6 |
| 15 | L5 | L5 | W1 |

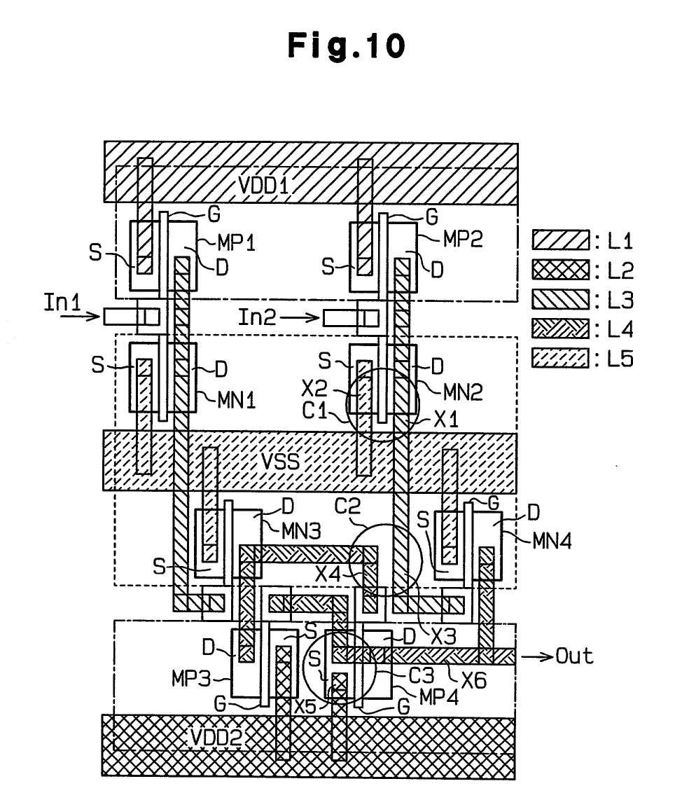

The CPU 12 lays out wires based on the netlist (FIG. 7), to which the potential attribute is added, as is the interval definition information. FIG. 10 shows the laid out wires. The CPU 12 shows the laid out wires on the display 15.

The portions encircled by first to third circles C1-C3 will now be discussed. The wire layers L1-L5 are each shown by different hatchings. The first circle C1 includes a wire X1, which is connected to the drain D of the transistor MN2, and a wire X2, which is connected to the source S of the transistor MN2. The potential at the wire X1, which is allocated to wire layer L3, is 0-VDD1(V). The potential at the wire X2, which is allocated to wire layer L5, is 0(V). The relationship between the wires X1 and X2 corresponds to number 12 in table 1. Accordingly, the distance between the wires X1 and X2 is greater than or equal to the wire interval W3.

The second circle C2 includes a wire X3, which is connected to the gate G of the transistor MN4 and a wire X4, which is connected to the gate G of the transistor MP4. The potential at the wire X3, which is allocated to wire layer L3, is 0-VDD1(V). The potential at the wire X4, which is allocated to wire layer L4, is 0-VDD2(V). The relationship between the wires X3 and X4 corresponds to number 11 in table 1. Accordingly, the distance between the wires X3 and X4 is greater than or equal to the wire interval W4.

The third circle C3 includes a wire X5, which is connected to the source S of the transistor MP4, and a wire X6, which is connected to the drain D of the transistor MP4. The potential at the wire X5, which is allocated to wire layer L2, is VDD2(V). The potential at the wire X6, which is allocated to wire layer L4, is 0-VDD2(V). The relationship between the wires X5 and X6 corresponds to number 8 in table 1. Accordingly, the distance between the wires X5 and X6 is greater than or equal to the wire interval W6.

Likewise, in the combination of other wires, the distance between two associated wires is greater than or equal to the wire intervals W1-W7 in correspondence with the potential differences S1-S7. Accordingly, the wires are spaced from one another by proper intervals in correspondence with the potential difference in each net.

The preferred and illustrated embodiment has the advantages described below.

(1) In the first step S31, nets having equal potentials are searched for based on a netlist, power supply names, and the voltages of power supply nets. This determines the potentials at each net in the semiconductor integrated circuit. In the second step S32, the wire intervals W1-W7 are set in correspondence with the potential differences S1-S7 between the nets, and the layout data of wires is generated in accordance with the wire intervals. In the layout data, the distance between wires is greater than or equal to the minimum value corresponding to the potential difference between nets. This prevents short-circuiting of wires that occurs when copper spreads out of the copper wires. Further, the distance between wires is generally set in correspondence with the potential difference between nets at a minimum value. Thus, the semiconductor integrated circuit, which has a plurality of power supplies VDD1, VDD2, is designed so that the wire density, or integrated level, is optimal.

(2) The potential difference attribute of each net is determined using the original netlist (FIG. 4) stored in the first file 21, the names and power supply voltages of the power supply nets stored in the second file 22, and the names and power supply voltages of the input nets stored in the third file 23. This eliminates the need to add the potential attribute one by one to each net. Accordingly, the potential attribute is quickly and accurately added.

(3) The CPU 12 allocates the wire layers L1-L5 in correspondence with each net potential, sets the wire intervals W1-W7 in accordance with the combination of the wire layers L1-L5, and lays out wires in accordance with the wire layers L1-L5 and the wire intervals W1-W7. The processing performed by the CPU 12 is relatively simple. Thus, the layout results are quickly obtained.

It should be apparent to those skilled in the art that the present invention may be embodied in many other specific forms without departing from the spirit or scope of the invention. Particularly, it should be understood that the present invention may be embodied in the following forms.

Instead of laying out wires of a semiconductor integrated circuit, the layout.apparatus 11 may be used to examine the intervals of laid out wires. More specifically, the CPU 12 reads the data of laid out wires from a predetermined file. Then, the CPU 12 performs the equal potential searching of the first step S31 to recognize the maximum potential at each net. Based on the netlist to which net potentials are added (FIG. 7) and the information of the wire intervals W1-W7 and the wire layers L1-L5, the CPU 12 examines whether the wire intervals in the wiring data is greater that or equal to reference values, or the wire intervals W1-W7. If a wire interval is smaller than a reference value in the wiring data, the CPU 12 indicates such state on the display 15. Accordingly, the user manipulates keys to correct the wiring data and optimize the wire interval.

In this case, the examining apparatus, which includes the main memory 13, the auxiliary memory 14, and the display 15, quickly and accurately examines the wiring data of wire layouts.

In another embodiment, instead of laying out wires of a semiconductor integrated circuit having two high potential power supplies VDD1, VDD2, the apparatus 11 may be used to lay out wires of a semiconductor integrated circuit having more power supplies.

It should also be noted that, in general, the potentials of each net are not limited to five. For example, the present invention may be applied to lay out wires in a semiconductor integrated circuit having three or more types of net potentials.

When applying the present invention to a semiconductor integrated circuit having multiple layer wires, the wire intervals may be set using information related to the number of increased layers in addition to the information of the combination of wire layers L1-L5 shown in FIG. 9.

The present examples and embodiments are to be considered as illustrative and not restrictive, and the invention is not to be limited to the details given herein, but may be modified within the scope and equivalence of the appended claims.

What is claimed is:

1. A method for laying out wires in a semiconductor integrated circuit, the method comprising the steps of:
recognizing potentials at nets, each net including at least one of the wires;
calculating potential differences between the nets using the recognized potentials at the nets;
determining wire intervals in correspondence with the calculated potential differences; and
generating wire layout data in accordance with the determined wire intervals.

2. The method according to claim 1, wherein the step for calculating the potential differences includes:
generating a matrix table including the recognized potentials at the nets; and
classifying the potential differences referring to the matrix table.

3. The method according to claim 2, wherein the step for determining the wire intervals includes:
determining the wire intervals in correspondence with each of the classified potential differences.

4. The method according to claim 1, wherein the step for recognizing the potentials includes generating a potential-recognized netlist, which includes information of the recognized potentials, by searching for equal potentials using information that includes an original netlist, names of power supply nets, and voltages of the power supply nets.

5. The method according to claim 4, wherein the step for generating the potential-recognized netlist includes locating nets of equal potentials and forming groups with the nets of equal potentials.

6. A method for examining wire layout data of a semiconductor integrated circuit having a plurality of wires, the method comprising the steps of:
recognizing potentials at nets, each net including at least one of the wires;
calculating potential differences between the nets using the recognized potentials at the nets;
setting reference wire intervals in correspondence with the calculated potential differences; and
examining whether the reference wire intervals are provided by comparing the reference wire intervals and wire intervals in the wire layout data.

7. An apparatus for laying out wires in a semiconductor integrated circuit having nets, each net including at least one of the wires, the apparatus comprising:
a memory for storing a netlist recognizing potentials at the nets; and
a processing unit for calculating potential differences between the nets based on information stored in the memory, determining wire intervals in correspondence with the calculated potential differences, and generating wire layout data in accordance with the determined wire intervals.

8. A program for laying out wires in a semiconductor integrated circuit, the program causing a computer to execute the steps of:
recognizing potentials at nets, each net including at least one of the wires;
calculating potential differences between the nets using the recognized potentials at the nets;
determining wire intervals in correspondence with the calculated potential differences; and
generating wire layout data in accordance with the determined wire intervals.

9. The program according to claim 8, further causing the computer to execute the step of:
classifying the potential differences by referring to a matrix table, which indicates the potential differences.

10. The program according to claim 9, further causing the computer to execute the step of:
determining the wire intervals in correspondence with each of the classified potential differences.

11. The program according to claim 10, further causing the computer to execute the step of:
generating a potential-recognized netlist based on information that includes an original netlist, names of power supply nets, and voltages of the power supply nets.

12. The program according to claim 11, wherein the step for generating the potential-recognized netlist includes locating nets of equal potentials and forming groups with the nets of equal potentials.

13. A computer readable recording medium storing a program for laying out wires in a semiconductor integrated circuit, the recording medium causing a computer to execute the steps of:
recognizing potentials at nets, each net including at least one of the wires;
calculating potential differences between the nets using the recognized potentials at the nets;
determining wire intervals in correspondence with the calculated potential differences; and
generating wire layout data in accordance with the determined wire intervals.

14. A method for designing the layout of a semiconductor integrated circuit including a plurality of wires, the method comprising the steps of:
recognizing potentials at nets, each net including at least one of the wires;
generating a potential-recognized netlist including information of the recognized potentials;
calculating potential differences between the nets using the potential-recognized netlist;
classifying the calculated potential differences;
setting reference wire intervals in correspondence with the calculated potential differences; and
generating layout data of the wires in accordance with the reference wire intervals.

15. The method according to claim 14, wherein the step for classifying the calculated potential differences includes generating a matrix table showing a combination of the potentials at the nets in relation with the calculated potentials.

16. The method according to claim 14, wherein the step for recognizing the potentials includes using information that includes an original netlist, names of power supply nets, and voltages of the power supply nets to recognize the potentials at the nets.

17. The method according to claim 16, wherein the step for generating the potential-recognized netlist includes locating nets of equal potentials and forming groups with the nets of equal potentials.

18. A method for examining wire layout data of a semiconductor integrated circuit having a plurality of wires, the method comprising the steps of:
recognizing potentials at nets, each net including at least one of the wires;
generating a potential-recognized netlist including information of the recognized potentials;
calculating potential differences between the nets using the potential-recognized netlist;
classifying the calculated potential differences;
setting reference wire intervals in correspondence with the calculated potential differences; and
examining whether wire intervals in the wire layout data satisfy the reference wire intervals by comparing the reference wire intervals with the wire intervals in the wire layout data.
